(19) United States
(12) Patent Application Publication
(10) Pub. No.: US 2016/0373991 A1
(43) Pub. Date: Dec. 22, 2016

(54) MULTIBEAM TELECOMMUNICATION SATELLITE, ASSOCIATED TELECOMMUNICATION SYSTEM AND HANDOVER METHOD

(71) Applicant: THALES, Courbevoie (FR)

(72) Inventors: Erwan CORBEL, TOULOUSE (FR); Cécile LARUE DE TOURNEMINE, TOULOUSE (FR); Bruno ROGER, TOULOUSE (FR); Pierre TAYRAC, TOULOUSE (FR)

(21) Appl. No.: 15/183,642

(22) Filed: Jun. 15, 2016

(30) Foreign Application Priority Data
Jun. 19, 2015 (FR) 1501278

(51) Int. Cl. H04W 36/30; H04L 5/00; H04W 4/02; H04B 7/185; H04B 7/04

(52) U.S. Cl. CPC H04W 36/30; H04B 7/18513; H04B 7/04; H04B 7/18541; H04W 4/02; H04L 5/0044

(57) ABSTRACT

A multibeam telecommunication satellite comprises a reconfigurable payload, at least one anchor spot access and a plurality of user spot accesses wherein, for a given mobile terminal, the anchor spot access is associated with a unique frequency channel and the user spot accesses are each associated with a frequency channel, and wherein the payload comprises at least one routing module configured to dynamically route the user spot access to the anchor spot access associated with the anchor station and vice versa depending on the position of the mobile terminal, and a transposition module configured to transpose the frequency of the RF signals that originate from the user spot accesses to the frequency associated with the frequency channel of the anchor spot access and vice versa, the transposition of the signals always being to the same frequency for a given mobile terminal.

### CROSS-REFERENCE TO RELATED APPLICATIONS

This application claims priority to foreign French patent application No. FR 1501278, filed on Jun. 19, 2015, the disclosures of which are incorporated by reference in their entirety.

### FIELD OF THE INVENTION

The present invention relates to the field of telecommunications via multibeam satellite. The present invention more particularly relates to a multibeam telecommunication satellite, an associated telecommunication system and a handover method in a multibeam telecommunication system.

### BACKGROUND

Currently, in order to guarantee the follow-up of established communications without service interruptions for mobile users of multibeam telecommunication systems, these systems reserve, for each user terminal, a dedicated passband for each of the possible pathways between the user spot and the anchor station. This leads to a passband being reserved that is much wider than that actually used.

By way of example, FIG. 2 shows a telecommunication system known from the prior art. This system comprises an anchor station 21 and a multibeam telecommunication satellite 22. The system is configured to allow fixed and/or mobile user terminals 23 to communicate.

For the user link, i.e. for the link between a user terminal 23 and the communication satellite 22, multibeam telecommunication systems conventionally propose frequency plans with M colours 15 (where M is an integer strictly greater than 1), without overlap between colours.

Referring to FIG. 1, it is recalled that frequency plans with M colours match a colour 15 to each of the beams 10 that are formed by the satellite 22, one colour 15 corresponding to one frequency band and one polarization, in such a way that the beams 10 of one and the same colour are not adjacent. Contiguous beams 10 therefore correspond to different colours. For a frequency plan with M colours 15, M sub-bands 150, or channels, are therefore reserved on the user link in order to cover the various possible positions of the mobile user terminal, as shown in FIG. 2 for the particular case of a frequency plan with four colours 15.

At each instant only one of the reserved bands 150 is used on the user side. This solution does not allow the optimization of the band reserved for mobile communications on the user link. Moreover, these channels 150 are located on separate frequency bands 15, meaning that the modem of the user terminal 23 must be reconfigured each time the mobile user changes beam 10 which consequently complexifies the handover process.

Referring to FIG. 2, the satellite 22 comprises a payload configured to transmit RF signals between the anchor station 21 and at least one user terminal 23. The payload of the satellite 22 comprises an anchor spot access 221 and a plurality of user spot accesses 222. The anchor spot access 221 is configured to receive and transmit RF signals originating from and destined for the anchor station 21. Likewise, the user spot accesses 222 are configured to receive and transmit RF signals.

In current payloads, the configuration of routes 20 that are used by the links between each user spot access 222 and the anchor spot access 221 is fixed or planned. For example, the first route 20 is associated with the first link connecting the anchor spot access 221 and the first user spot access 222. By convention, the uppermost user spot access in FIG. 2 will be considered as the first user spot access and the lowermost as the last. The second route 20 is associated with the second link connecting the anchor spot access 221 and the second user spot access 222 and so on. Consequently, in order to ensure communications between the anchor station 21 and each of the beams 10 of the coverage of the satellite 22, it is necessary to reserve as many routes 20 between the anchor station 21 and the anchor spot access 221 as there are possible positions of the mobile user terminal 23 within the beams 10 formed by the satellite 22. This translates into a reservation of as many routes 20, and hence as many frequency sub-bands 25, or mobile channels, as there are beams 10 ensuring coverage. This solution is not optimal as at each instant, only one frequency band 250 on the anchor station 21 side is used, and hence only a fraction of the reserved frequency band is used.

### SUMMARY OF THE INVENTION

One aim of the invention is, in particular, to remedy all or some of the drawbacks of the prior art by proposing a solution that allows the management of the movement of user terminals within a multibeam telecommunication system to be optimized.

To this end, a subject of the invention is a multibeam telecommunication satellite comprising a reconfigurable payload, at least one anchor spot access and a plurality of user spot accesses, said payload being configured to transmit RF signals between at least one anchor station and at least one user terminal via said anchor spot access and said user spot accesses, said anchor spot access being capable of receiving and/or transmitting RF signals originating from and/or destined for at least one anchor station, said user spot accesses being capable of receiving and/or transmitting RF signals originating from and/or destined for at least one user terminal by forming beams,
said satellite being characterized in that, for a given mobile user terminal, said anchor spot access is associated with a unique frequency channel for the link between the satellite and an anchor station and said user spot accesses are each associated with a frequency channel for the link between the satellite and said mobile user terminal,
and in that the payload comprises at least one routing module configured to dynamically route the user spot access that is associated with the beam within which said mobile user terminal is located to the anchor spot access that is associated with the anchor station and vice versa depending on the position of the mobile user terminal, and a transposition module configured to transpose the frequency of the RF signals that originate from the user spot accesses to the frequency associated with the frequency channel of the anchor spot access and vice versa, the transposition of the signals from the user spot accesses always being to the same frequency for a given mobile user terminal.

According to one embodiment, the payload comprises at least one digital transparent processor.

According to one embodiment, each user spot access is associated with a frequency band such that the set of said frequency bands comprises a shared frequency sub-band.

According to one embodiment, for a given mobile user terminal, each user spot access is associated with one and the same frequency channel.

According to one embodiment, the payload comprises a handover module configured to analyse the power of the electromagnetic signals originating from each user spot access and determine which user spot access delivers a signal with higher amplitude.

According to one embodiment, the handover module is configured to initiate a handover as soon as the amplitude of the electromagnetic signal from one mobile user terminal falls below a predetermined floor value.

According to one embodiment, the handover module is configured to send a message in the direction of the anchor station as soon as the amplitude of the electromagnetic signal from one mobile user terminal falls below a predetermined floor value so that said anchor station initiates a handover.

According to one embodiment, the mobile user terminal is configured to transmit its location to the anchor station, and in which the payload comprises a handover module that is configured to initiate a handover on the basis of information provided by said anchor station.

Another subject of the invention is a multibeam telecommunication system comprising at least one multibeam telecommunication satellite as described above and at least one anchor station.

Another subject of the invention is a handover method that is capable of being implemented by a multibeam telecommunication system, comprising:
a step of dynamically routing RF signals between the anchor spot access and the user spot access that are associated with the mobile user terminal depending on the position of said mobile user terminal within the beams that are formed by the multibeam telecommunication satellite, and
a step of transposing the frequency of the RF signals that originate from the user spot accesses to the frequency associated with the frequency channel of the anchor spot access and vice versa, the transposition of the signals from the user spot accesses always being to the same frequency for a given mobile user terminal.

According to one mode of implementation, the handover is initiated by the payload of the satellite based on information provided by the handover module that analyses the power of the electromagnetic signals originating from each user spot access for a given mobile user terminal.

According to one mode of implementation, the handover is initiated by the anchor station based on information provided by the handover module that analyses the power of the electromagnetic signals originating from each user spot access for a given mobile user terminal.

According to one mode of implementation, the handover is initiated by the anchor station based on information provided by the mobile user terminal, said mobile user terminal transmitting its location to the anchor station.

The main advantages of the invention are to reduce the band reserved for mobile communications over multibeam coverage and to simplify handover procedures at the level of the mobile terminal.

### BRIEF DESCRIPTION OF THE DRAWINGS

Other particularities and advantages of the present invention will become more clearly apparent upon reading the description which follows, given by way of non-limiting illustration and with reference to the appended drawings in which:

FIG. 1 illustrates the frequency band reservation on the user side in a multibeam telecommunication system known from the prior art;

FIG. 2 shows an exemplary telecommunication system known from the prior art;

FIG. 3 illustrates an exemplary handover procedure in one exemplary embodiment of a multibeam telecommunication system according to the invention;

FIG. 4 shows an exemplary frequency band reservation on the user link in an exemplary embodiment of a multibeam telecommunication system according to the invention;

FIG. 5 illustrates an exemplary handover procedure in one exemplary embodiment of a multibeam telecommunication system according to the invention;

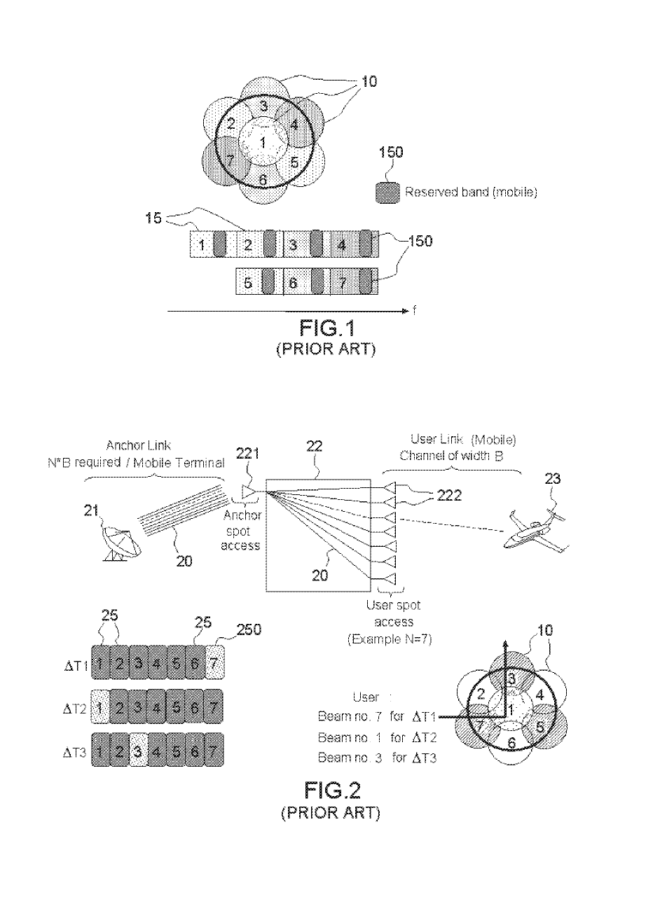

### DETAILED DESCRIPTION

Hereinafter, the RF link between an anchor station 21 and a telecommunication satellite 22 will be referred to as an “anchor link”, both for the uplink and the downlink. Likewise, the RF link between at least one user terminal 23 and a telecommunication satellite 22 will be referred to as a “user link”, both for the uplink and the downlink.

The term “spot access” denotes an antenna system forming an antenna diagram. The terms “anchor spot access” 221 will be referred to for the anchor link and “user spot access” 222 will be referred to for the user link. The anchor spot accesses 221 and user spot accesses 222 may be combined or separate antenna systems.

Likewise, it should be noted that the use of the term “terminal” denotes any type of terminal that is liable to be used with the telecommunication system of the invention. It may be a fixed or mobile terminal.

The present invention relates to the management of the movement of user terminals in systems for telecommunication via multibeam satellite.

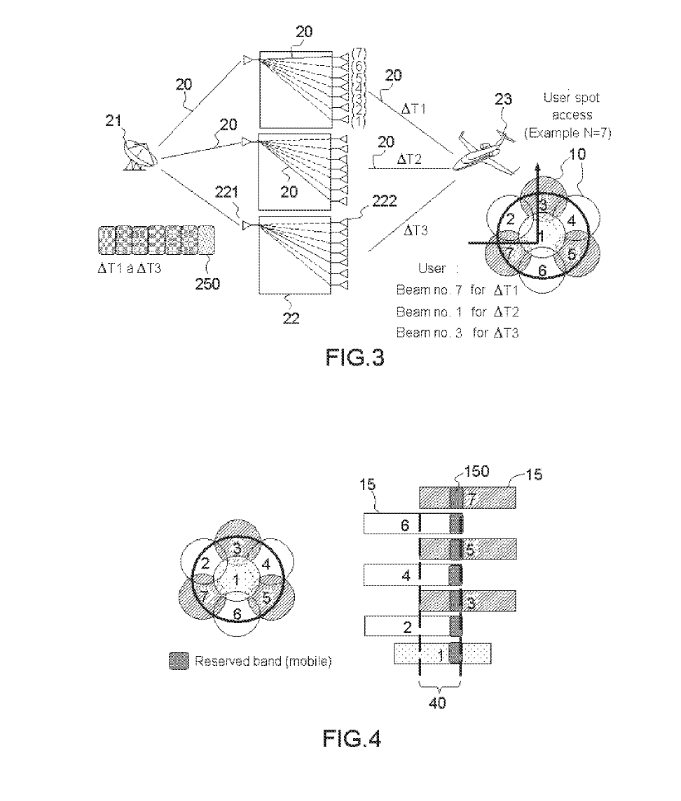

FIG. 3 shows one embodiment of a telecommunication system according to the invention. The system may comprise at least one anchor station 21 and at least one telecommunication satellite 22. The system is configured to allow fixed and/or mobile user terminals 23 to exchange data. The user, and hence his or her terminal 23, may be on the ground, within a coverage area of the satellite 22, or in the air, e.g. on board an aircraft.

The telecommunication satellite 22 is a multibeam satellite comprising a reconfigurable payload. The payload is configured to make RF signals pass between at least one anchor station 21 and at least one user terminal 23. The payload of the satellite 22 comprises one or more anchor spot accesses 221 and a plurality of user spot accesses 222. Each anchor spot access 221 is configured to receive and transmit RF signals originating from and destined for at least one anchor station 21. Likewise, the user spot accesses 222 are configured to receive and transmit RF signals originating from and destined for at least one user terminal 23 by forming beams 10. According to one embodiment, the payload may comprise at least one digital transparent processor.

In order to optimize the passband of the frequency plan, a sole frequency channel 250 is reserved on the anchor link for the exchanges of electromagnetic signals of a given mobile user terminal 23. This channel may be changed through planning, but remains constant throughout a communication between the anchor station and the user terminal. Regardless of the position of the mobile user terminal 23 within the beams 10 formed by the satellite 22, the link between the satellite and the anchor station 21 will always be made through this unique frequency channel 250. As for the user spot accesses 222, they are each associated with a frequency channel 150, of identical or different frequency, for the link between the satellite 22 and the mobile user terminal 23.

When the user of the mobile terminal moves and passes from one beam 10 to another, his or her electromagnetic signal is switched to a different user spot access 222 and must be routed to the anchor spot access 221 that is associated with the communication of said user of the mobile terminal. To this end, the payload may comprise reconfigurable routes between each anchor spot access 221 and the user spot accesses 222, as well as a dynamic routing module configured to route the user spot access 222 that is associated with the beam 10 within which the mobile user terminal 23 is located to the anchor spot access 221 that is associated with the anchor station and vice versa. This module dynamically carries out the routing depending on the change in the position of the mobile user terminal 23 within the beams 10 of the coverage of the communication satellite 22. Thus, in contrast to the case described above, the configuration of the routes 20 between the mobile user terminal 23 and the associated anchor station is no longer fixed, but is dynamically reconfigured depending on the movement of the mobile terminal within the beams 10. The reconfiguration of the routing may be initiated, for example, with the aid of an algorithm stored in a storage area of the payload.

The payload may also comprise a transposition module configured to transpose the frequency of the RF signals that originate from the user spot accesses 222 to the frequency associated with the frequency channel 250 of the anchor spot access 221 and vice versa. As the frequency channel associated with the anchor spot access 221 is the same for a given mobile user terminal 23 regardless of the position of said terminal 23, the frequency transposition of the signals from the user spot accesses 222 is always to the same frequency. The frequency transposition of the signals may be carried out, for example, with the aid of an algorithm stored in a storage area of the payload.

FIG. 3 also illustrates, with an example, the handover method in the specific case of a telecommunication system with seven beams 10 and a frequency plan with three colours. Of course, this example is in no way limiting and may be extended to a more general case with N beams and M colours where M and N are non-zero integers.

It is assumed that during the time period ΔT1, the mobile user terminal 23 is located within the beam no. 7. The electromagnetic signals of the communications between the user terminal 23 and the anchor station 21 pass through a “route” 20 that connects the anchor spot access and the user spot access no. 7.

Once at the start of the time period ΔT2, the mobile user terminal 23 exits the beam no. 7 and enters the beam no. 1, the routing module automatically reconfigures the route 20 so that it connects the user spot access no. 1 to the anchor spot access 221. Likewise, the transposition module may be reconfigured in order to transpose the electromagnetic signals from the anchor station 21 to the frequency of the new frequency channel 150 that is associated with the user spot access no. 1 and vice versa.

The same process is reproduced between the time period ΔT2 and the time period ΔT3 when the mobile terminal 23 passes from the beam no. 1 to the beam no. 3.

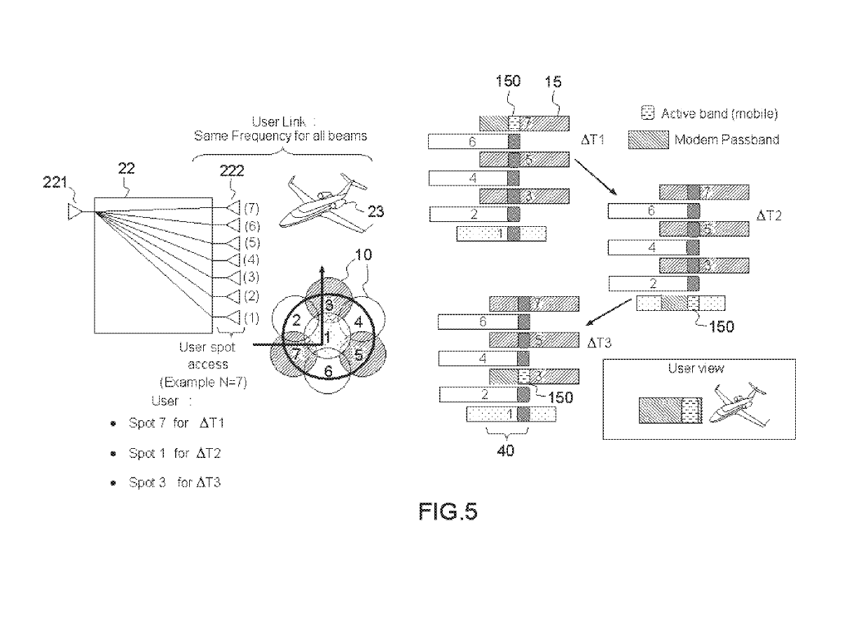

According to one embodiment illustrated in FIGS. 4 and 5, in order to optimize the frequency plan on the user link, the frequency bands 15 of said frequency plan may be chosen so that each of these frequency bands overlaps and has a shared frequency sub-band 40. Such a frequency plan is illustrated in FIG. 4 via an example with three colours with overlap. The frequency channels 250 that are associated with the mobile user terminals 23 are chosen within this shared frequency sub-band 40. Thus, for a given mobile user terminal 23, each user spot access 222 is associated with one and the same unique frequency channel 250. Advantageously, when a mobile user terminal 23 is moved through the beams 10 of the satellite 22, it is no longer necessary to carrier-hop each time the terminal passes from one beam to another. The mobile user terminal 23 keeps its carrier at the same frequency regardless of the beam 10 in which it is located. This allows the handover process to be simplified. Moreover, as the frequency channels 250 associated with each user spot access 222 are identical, the telecommunication system is not obliged to reserve as many frequency channels 250 as there are user spot accesses 222.

According to one embodiment, the payload of the telecommunication satellite may comprise a handover module. This module is intended to manage the movements of the mobile user terminals 23 through the various beams 10 formed by the satellite 22. The handover module may carry out the handovers with the aid of an algorithm stored in a storage area of the payload. It may, for example, detect the instant at which the mobile terminal 23 changes beam and to which beam 10 it is heading. In order to do this, the handover module may be configured to analyse the power of the electromagnetic signals originating from each user spot access 222.

According to one variant embodiment, the handover decision may be based on information from outside the payload, transmitted, for example, by the mobile user terminals 23, collected and transferred by the anchor station.

The module may, for example, locate a mobile user terminal 23 by measuring the power of the electromagnetic signals at each user spot access 222 and by determining at which user spot access the signal at the frequency associated with the terminal 23 in question has the highest amplitude.

The handover module may detect the passage of a mobile terminal 23 from one beam 10 to another, for example, by detecting a decrease in the amplitude of the electromagnetic signal from a mobile user terminal 23. At the same time, it may detect to which beam 10 the mobile terminal 23 is heading by detecting an increase in the amplitude of an electromagnetic signal at another user spot access 222. When the signal of the spot access 222 in which the mobile user terminal 23 was located falls below a predetermined floor value, the handover module may assume that the terminal has exited the beam.

According to another mode of implementation, when the handover module is monitoring the amplitude of the electromagnetic signals from the user spot accesses 222, if it detects a rise in the amplitude of a signal at a user spot access other than that associated with the beam 10 in which the mobile user terminal 23 is located, the handover module may get ready to carry out a handover to another beam and as soon as the amplitude of the signal reaches a predetermined threshold value, it carries out said handover. The handover may be carried out, for example, when the amplitude of the electromagnetic signal at the user spot access 222 other than that associated with the beam in which the mobile user terminal 23 in question is located becomes substantially equal to the amplitude of the signal at the user spot access 222 that is associated with the beam in which the mobile user terminal 23 in question is located.

According to one mode of implementation of the handover, when the handover module detects the passage of a mobile user terminal from one beam to another, it may transmit a message in the direction of the anchor station 21 so that the latter initiates the handover process. The message may, for example, indicate to the anchor station 21 which terminal is changing beam, the old beam and the new beam in which it is located. The anchor station 21 may thus notify, inter alia, the routing and transposition modules so that the routing module reconfigures the route 20 between the anchor spot access 221 and the new user spot access 222 and so that the transposition module modifies its algorithm in order to transpose the electromagnetic signals from the mobile user terminal 23 in question to the new frequency.

According to a variant embodiment, the handover may be initiated by the payload on the basis of information from outside the payload, e.g. a location provided by the terminal to the anchor station. To this end, the mobile user terminal 23 may be configured to transmit its location to the anchor station. As soon as the anchor station detects that the mobile user terminal 23 is exiting the coverage of the beam 10, said anchor station sends a message to the handover module of the payload so that the latter initiates a handover.

In the various modes of implementation that have been presented, the handover module may carry out the handovers with the aid of an algorithm stored in a storage area of the payload.

According to another mode of implementation, the payload may be quasi-autonomous. In this case, it is the handover module that initiates the handover process, without intervention from outside the payload or information transmitted by the anchor station or the mobile user terminal 23. The handover module notifies the various modules of the payload of the change of beam 10.

Thus, handovers may be carried out by the payload directly, e.g. by a handover module, or indirectly, e.g. by the anchor station 21. In both cases, the handover may be carried out with the aid of information provided by the payload, e.g. via the handover module. This information may be, for example, the position of the mobile user terminal 23 within the beams 10, the power of the signal in each user spot access 222, the passage of a mobile user terminal 23 from one beam 10 to another or any other information required for the handover.

The various modules described above may be one or more microprocessors, processors, computers or any other equivalent appropriately programmed means.

1. A multibeam telecommunication satellite comprising a reconfigurable payload, at least one anchor spot access and a plurality of user spot accesses, said payload being configured to transmit RF signals between at least one anchor station and at least one user terminal via said anchor spot access and said user spot accesses, said anchor spot access being capable of receiving and/or transmitting RF signals originating from and/or destined for at least one anchor station, said user spot accesses being capable of receiving and/or transmitting RF signals originating from and/or destined for at least one user terminal by forming beams,
said satellite wherein, for a given mobile user terminal, said anchor spot access is associated with a unique frequency channel for the link between the satellite and an anchor station and said user spot accesses are each associated with a frequency channel for the link between the satellite and said mobile user terminal,
and wherein the payload comprises at least one routing module configured to dynamically route the user spot access that is associated with the beam within which said mobile user terminal is located to the anchor spot access that is associated with the anchor station and vice versa depending on the position of the mobile user terminal, and a transposition module configured to transpose the frequency of the RF signals that originate from the user spot accesses to the frequency associated with the frequency channel of the anchor spot access and vice versa, the transposition of the signals from the user spot accesses always being to the same frequency for a given mobile user terminal.

2. The satellite according to claim 1, wherein the payload comprises at least one digital transparent processor.

3. The satellite according to claim 1, wherein each user spot access is associated with a frequency band such that the set of said frequency bands comprises a shared frequency sub-band.

4. The satellite according to claim 3, wherein, for a given mobile user terminal, each user spot access is associated with one and the same frequency channel.

5. The satellite according to claim 4, wherein the payload comprises a handover module configured to analyse the power of the electromagnetic signals originating from each user spot access and determine which user spot access delivers a signal with higher amplitude.

6. The satellite according to claim 5, wherein the handover module is configured to initiate a handover as soon as the amplitude of the electromagnetic signal from one mobile user terminal falls below a predetermined floor value.

7. The satellite according to claim 5, wherein the handover module is configured to send a message in the direction of the anchor station as soon as the amplitude of the electromagnetic signal from one mobile user terminal falls below a predetermined floor value so that said anchor station initiates a handover.

8. The satellite according to claim 1, wherein the mobile user terminal is configured to transmit its location to the anchor station, and wherein the payload comprises a handover module that is configured to initiate a handover on the basis of information provided by said anchor station.

9. A multibeam telecommunication system, comprising at least one multibeam telecommunication satellite according to claim 1 and at least one anchor station.

10. A handover method that is capable of being implemented by a multibeam telecommunication system according to claim 9, comprising:
a step of dynamically routing RF signals between the anchor spot access and the user spot access that are associated with the mobile user terminal depending on the position of said mobile user terminal within the beams that are formed by the multibeam telecommunication satellite, and
a step of transposing the frequency of the RF signals that originate from the user spot accesses to the frequency associated with the frequency channel of the anchor spot access and vice versa, the transposition of the signals from the user spot accesses always being to the same frequency for a given mobile user terminal.

11. The method according to claim 10, wherein the handover is initiated by the payload of the satellite based on information provided by the handover module that analyses the power of the electromagnetic signals originating from each user spot access for a given mobile user terminal.

12. The method according to claim 10, wherein the handover is initiated by the anchor station based on information provided by the handover module that analyses the power of the electromagnetic signals originating from each user spot access for a given mobile user terminal.

13. The method according to claim 10, wherein the handover is initiated by the anchor station based on information provided by the mobile user terminal, said mobile user terminal transmitting its location to the anchor station.
